(19) United States
(12) Patent Application Publication
(10) Pub. No.: US 2019/0050920 A1
(43) Pub. Date: Feb. 14, 2019

(54) DYNAMIC GROUP PURCHASE FLOWS USING AUTHORIZED TEMPORAL PAYMENT TOKENS

(71) Applicant: eBay Inc., San Jose, CA (US)

(72) Inventors: Sudeep Kumar, Campbell, CA (US); Deepak Kumar Vasthimal, Karnataka (IN)

(21) Appl. No.: 15/920,959

(22) Filed: Mar. 14, 2018

(30) Foreign Application Priority Data
Aug. 9, 2017 (IN) 201741028363

(51) Int. Cl. G06Q 30/06; G06Q 20/12; G06Q 20/38

(52) U.S. Cl. CPC G06Q 30/0605; G06Q 30/0609; G06Q 20/385; G06Q 20/12; G06Q 30/0633

(57) ABSTRACT

Systems, methods and media are provided for operating a group purchase event in a networked system. An example method comprises initiating a digital instance of a group purchase event and defining a target balance, identifying a potential contributor list from a social or community group, transmitting an electronic communication to first and second parties on the potential contributor list via an electronic communication pathway, and based on a received response to the electronic communication, authorizing the first and second parties to participate in the group purchase event. One example identifies and presents, in a display of an electronic device, a list of items purchasable at prices less than or equal to a current balance of a money pool, and monitors changes in the current balance. Based on a change in the current balance, the displayed list of items is dynamically updated.

### CLAIM OF PRIORITY

This application claims the benefit of priority to Kumar, Indian Patent Application No. 201741028363 filed Aug. 9, 2017, entitled “DYNAMIC GROUP PURCHASE FLOWS USING AUTHORIZED TIME-BASED PAYMENT TOKENS”, which is incorporated herein by reference in its entirety.

### TECHNICAL FIELD

The present application relates generally to the field of data processing and, in one specific example, to a method and system for group purchase facilitation using authorized time-based payment tokens.

### BACKGROUND

Conventional group purchase methods employ shared-cart or other similar money-pool mechanisms. However, such techniques are not tightly integrated with online commerce. Present transaction flows are extremely clumsy and present problems when a few people who were committed participants in a group purchase effort do not actually end up contributing money to the pool. There are also no dynamic product suggestions based on the total money pool collected in conventional shared-cart or similar systems.

BRIEF-DESCRIPTION OF THE DRAWINGS

Some embodiments are illustrated by way of example and not limitation in the figures of the accompanying drawings.

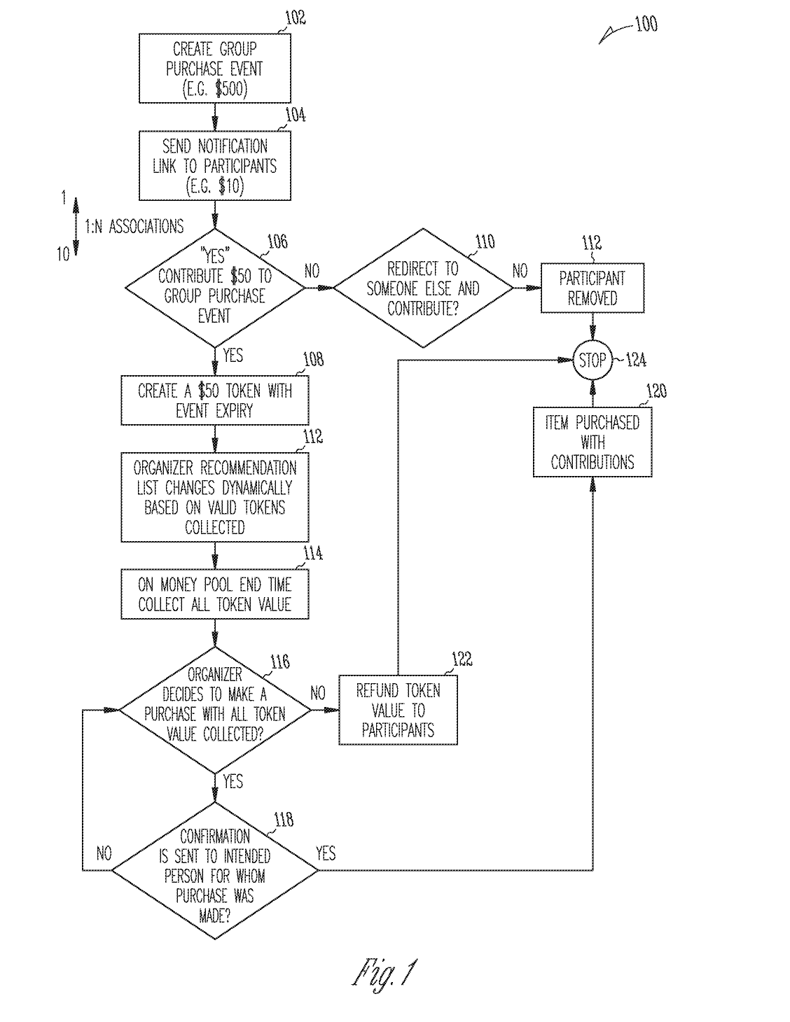

FIG. 1 illustrates a flow chart for a method of operating a group purchase event, according to an example embodiment.

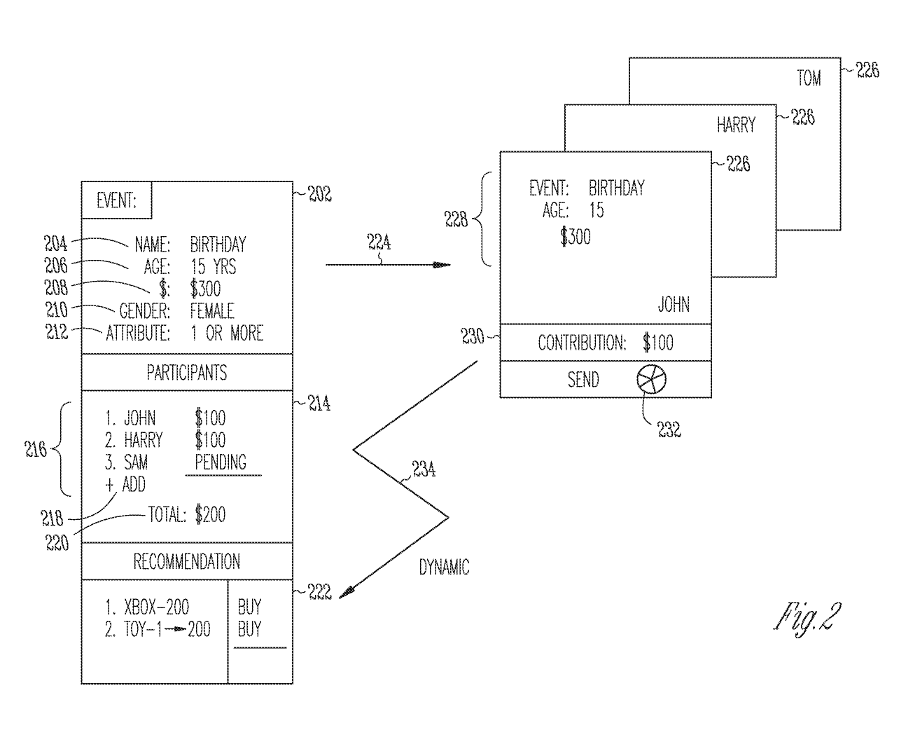

FIG. 2 pictorially illustrates example UI's in a group purchase event system, according to example embodiments.

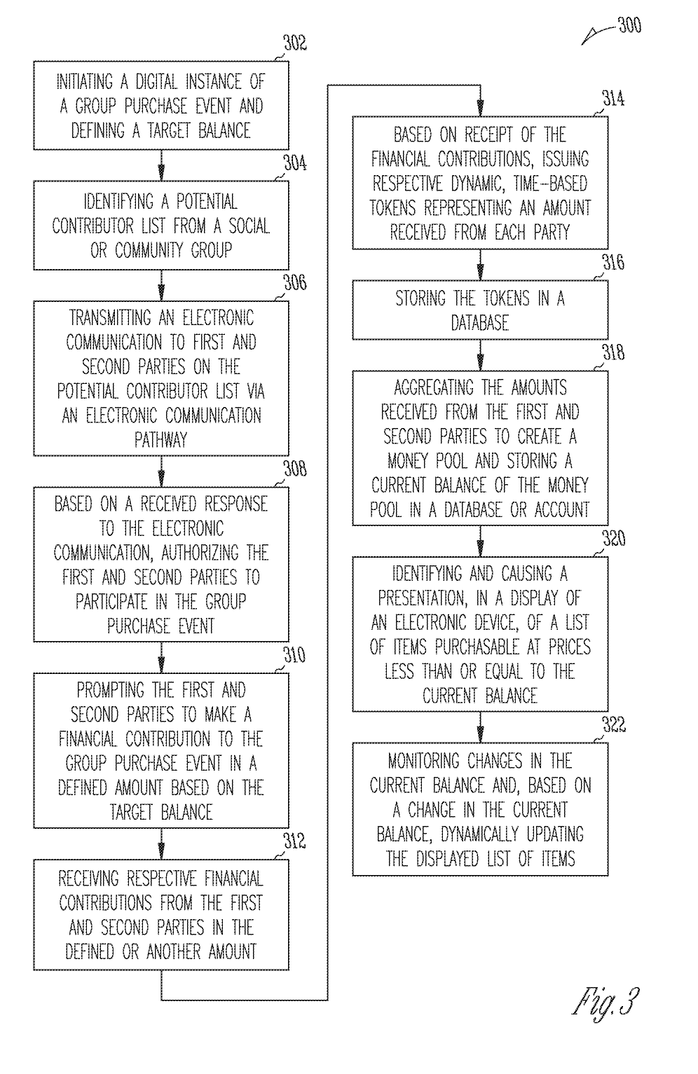

FIG. 3 illustrates a flow chart for another method of operating a group purchase event, according to an example embodiment.

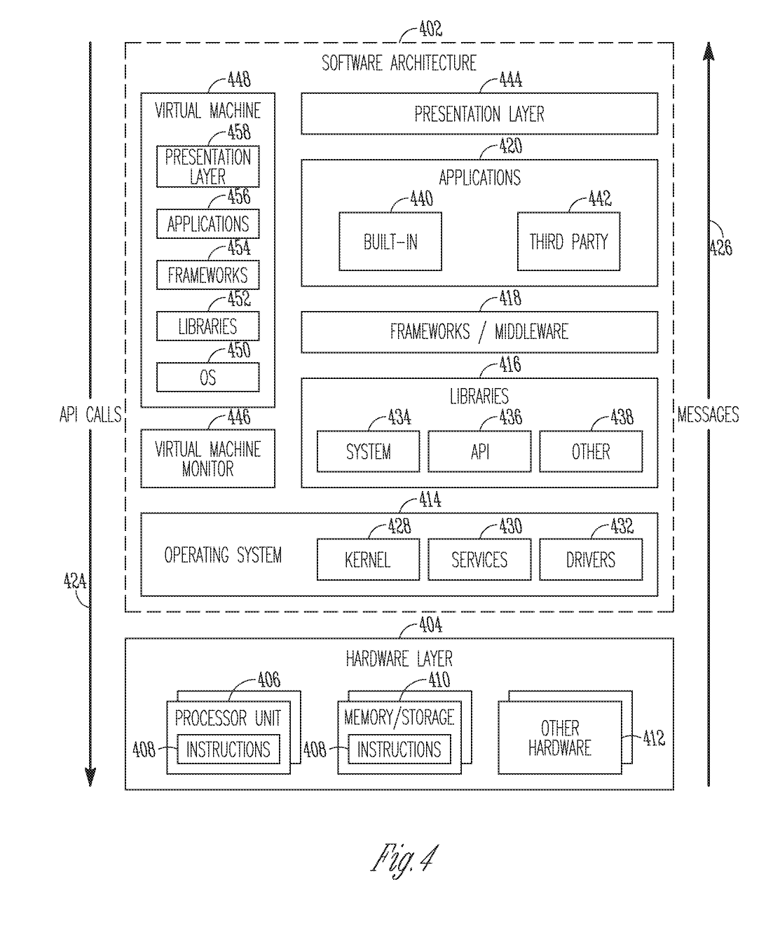

FIG. 4 is a block diagram illustrating an example of a software architecture that may be installed on a machine, according to some example embodiments.

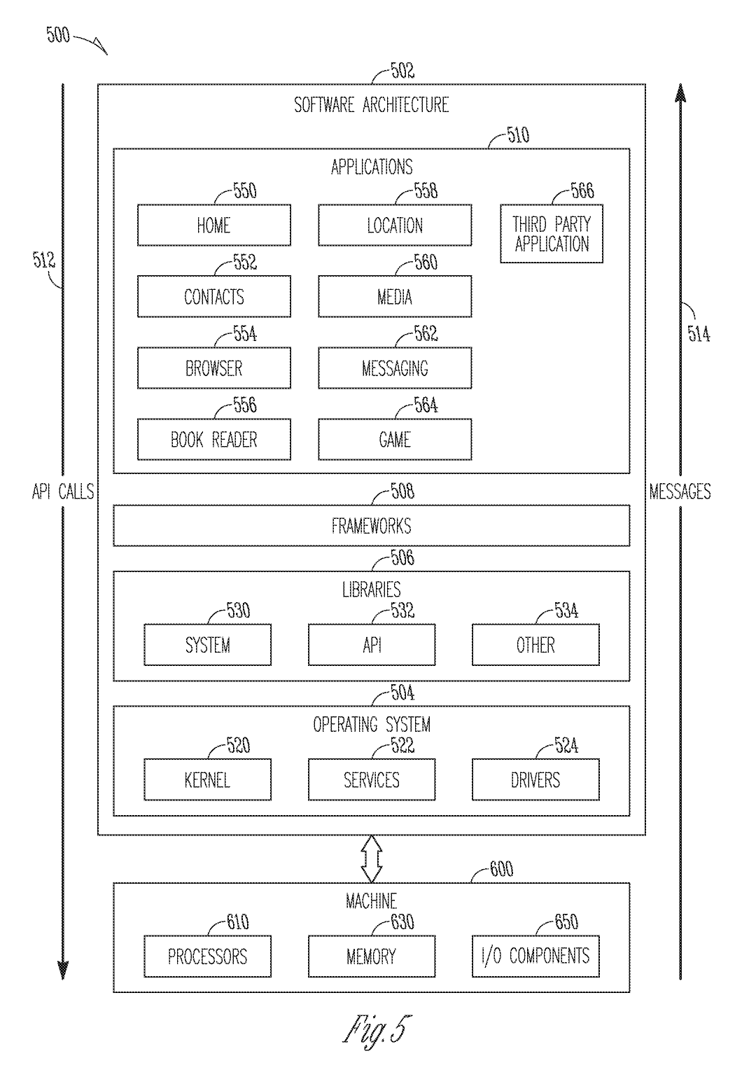

FIG. 5 is a block diagram illustrating an architecture of software, according to some example embodiments.

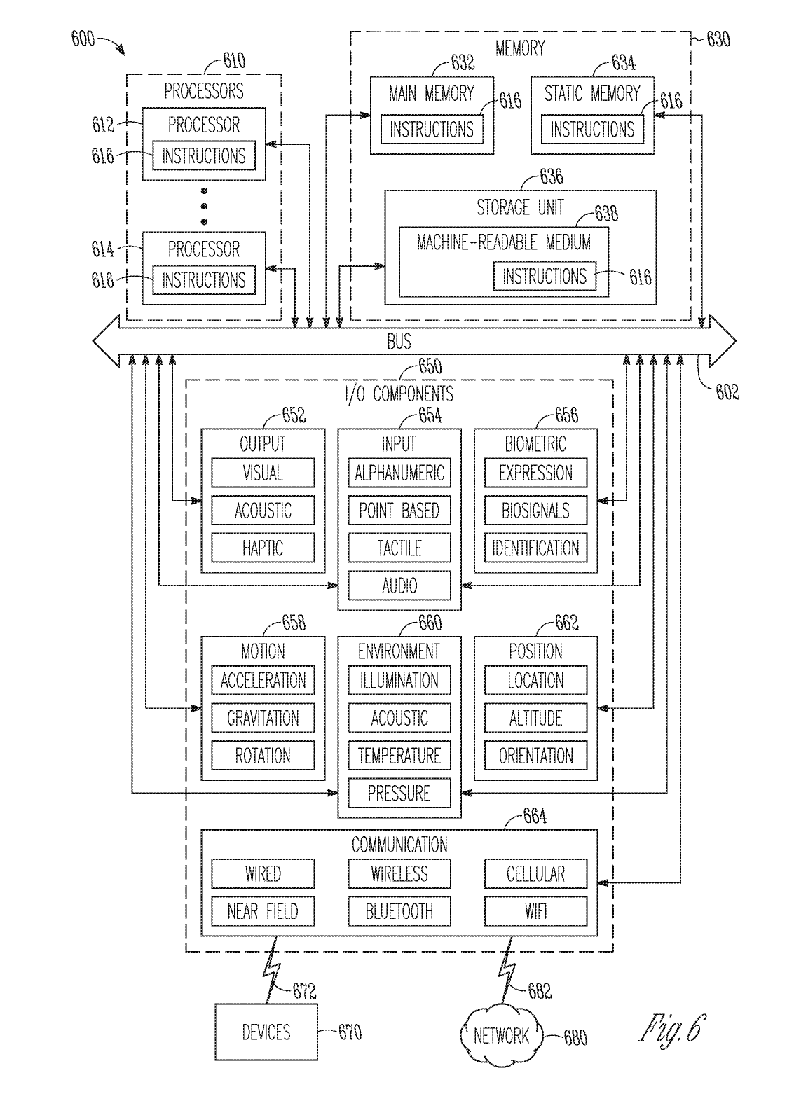

FIG. 6 is a diagrammatic representation of a machine in the example form of a computer system within which a set of instructions, for causing the machine to perform any one or more of the methodologies discussed herein, may be executed.

### DETAILED DESCRIPTION

Example methods and systems for group purchase event facilitation are described. In the following description, for purposes of explanation, numerous specific details are set forth in order to provide a thorough understanding of example embodiments. It will be evident, however, to one skilled in the art that the present inventive subject matter may be practiced without these specific details.

Although the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

Although many “shared-cart” or “money-pool” systems for online commerce are available today, no actual financial commitment is made by participants in such systems unless money is actually handed or wired to an administrator or organizer of such a shared cart or pool. Once a pooled amount is received, the organizer has complete control of any subsequent purchase made by using the collected funds. Moreover, even though online options are available, collections made by participants are usually effected offline (e.g., by cash), and in any event are not integrated with online commerce availability or payment flows. As an example of such a difficulty, if ten members in a shared group purchase event managed by an organizer commit to purchase a gift, but only seven members actually contribute, then the intended group product (for example, dwelling, motor vehicle, gift) cannot be purchased by the organizer as there are insufficient funds.

In one example of the present system, however, a dynamic list of different items available for potential purchase in a group purchase event is created. The list is based, in one example, on the aggregate of a present collected amount. Other bases are possible. The different items may be listed for sale on an ecommerce platform. The dynamic list may be tailored based on a set of preferences that the organizer may establish for the event. These aspects are not leveraged in current systems. Additionally, although today's systems may allow more participants to be added to “shared-cart” systems, split values are not dynamically changed for future participants and there is no voting option for participants to vote on an item to be purchased by an organizer, Moreover, in present systems, there is no confirmation mechanism whereby a person for whom a purchase was made can endorse the results of a vote, or make a selection of an item in the dynamic list.

In some examples, these technical problems are addressed by a technical solution which invokes a combination of two flows. One flow includes the use of authorized, time-based payment tokens having a dynamic financial value, and the other flow includes the generation and presentation of dynamic recommendations to an organizer based on identified preferences and an aggregate amount collected in a group purchase event.

In one example using the first flow, a participant in a group purchase event receives a notification from the event organizer (also termed an “administrator” herein) via his or her mobile device or a home page of the establishment of such an event. This event may also be termed a “social event” in this specification. The notification may, for example, include a link to a website or, more conveniently, be included in an “app” allowing payment, authorization, participant and event status checking, and display functionality. The event organizer can authorize the participant's contribution to the event via the app, such as by invoking Touch ID or online authorization, for example. Once authorized, a payment can be made by the participant via the app to receive a valid payment token. In some examples, this payment token includes data relating to at least three aspects: a token expiry date after which the token amount will automatically be refunded to the participant's account, a token owner with a token amount, and an associated group purchase (or social) event for a token. The initial set-up notification can be redirected to other trusted devices or can be used to add more participants to the event.

Continuing the example using the second flow, the organizer of the event receives participant tokens, and a pool of money keeps building up. Based on identified preferences set for the event and a total collected token value, a dynamic list of purchase recommendations is shown by the app to the organizer (in an organizer view) to facilitate the actual purchase of a listed item or product.

Some use cases will now be described. In other examples, suppose that a group of ten friends decides to buy a gift worth $500 collectively for their friend's (A's) birthday. Optionally, friend A can share a list of items he or she may be interested in. An organizer (B) creates a social event using a networked app of the present disclosure, populates it with friend A's item preferences (Xbox, Sudoku, and so forth), and sets an end date for contribution commitments. The organizer (B) then adds all participating friends to the event. A notification is sent to all participants to commit $50 for the gift.

A time-based payment token worth $50 is generated by a token generator and is associated with the social event. Now suppose that out of the ten friends, only five contribute, with the result that only $250 is collected. A dynamic list of items falling within the parameters of the preferences, and based on the collected total thus far (i.e., having a purchase price less than $250 in this example), is displayed via the app to the organizer (B). As more people contribute or drop, the item list will change dynamically.

Suppose further that the organizer (B) sends the notification to others in an effort to rally support. Fifteen people, for example, now commit with their respective payment tokens, making the dynamic average token value $33.33 for a $500 gift. A balance of $16.67 for each token can be returned to the participants, or optionally a $750 (15 times $50) gift can now be purchased.

Thus, it will be seen that if more participants join the event, some residual token value is automatically refunded to each participant's account based on an increase in the number of participants in the group purchase event. The token value is dynamically changed based on an increase of participants for all future participant additions. The tokens are time-limited so that they expire and a full refund is made if the event is canceled, or a purchase is not made. The organizer (B) gets real-time recommendations of purchasable products based on preferences set for social events and the aggregate amount of token value collected. In the event that an organizer decides to purchase a product, he or she can order it online directly through the app and receive a purchase confirmation, and shipping can optionally be redirected to the person (friend A) for whom the product was intended.

Reference is now made to FIG. 1, which illustrates a flow chart for a method 100 of operating a group purchase event in a networked system of components (described further below) and connected participants. At operation 102, a group purchase event is set up by an organizer, for example using an app (see further below). Aspects associated with the established event may include an event type such as birthday, retirement, and so forth; a social calendar link; a monetary, amount for a money pool (e.g., $500); and an expiry date for the event.

At operation 104, an electronic notification, for example including a link, is sent to an initial group of participants in the pool (e.g.,; 10), for example using a messaging, email, or URL system available in the app. A participant wishing to join the group can respond to the notification and be authorized by the organizer using Touch ID, or other authenticating credentials. In this way, a number of event associations (1:n) can be established, for example 10 associations.

At operation 106, if a participant wishes to confirm participation and has been authorized, he or she can contribute online (via the app) a pro rata share (e.g., $50) of the money-pool amount (e.g.; $500) into an account set up for the event, or established by the organizer.

in response, at operation 108, a dynamic, time-based token is created for the participant. The token may have one or more aspects associated with it (e.g., carried as coded data), namely an identification of the group purchase event for which it has been issued, a token amount (e.g., $50), a token expiry time, and a token contributor (or owner).

If the initial participant does not wish to join the event or contribute money, in operation 110 an event notification (of the type sent in operation 104) may be sent to another potential participant with an invitation to join. The participant pool may thus be dynamic. But this changing environment can be handled easily and conveniently by the technically improved system of the present subject matter, in particular the dynamic, time-based tokens and the flows discussed further above. The tokens are dynamic in value as the number of participants increases, or decreases, or as the money-pool amount increases or decreases, and are time-based in the sense that they expire at a designated time, triggering a refund to the token owners, as the case may be. If one or more participants elect not to join, they can be removed from the event at operation 112. In one example, the preceding operations may be considered to form part of a “flow one” (or “first flow”).

In the same example, a “flow two” (or “second flow”) includes at operation 112 the dynamic presentation to the organizer of a recommendation list of potential items available for purchase at listed prices. The pricing of the items in the list is based on the number of valid tokens collected, i.e., the aggregate amount in the money pool. The data for recommendations and listed prices may be sourced from one or more ecommerce platforms, and be presented to the organizer in an “organizer” view in the app, or be shown continuously to all participants in their own view in the app. The listed items may be rendered directly purchasable via the app using appropriate hyperlinks and so forth.

In operation 114, at the expiry of the event, all the token values are collected and an aggregate amount in the money pool is established.

In operation 116, the organizer can decide to purchase a listed item, for example if it is deemed worthy or satisfactory for the recipient and/or an intended use, or meets certain attributes or falls within certain preference ranges. The attributes and preferences may be set by the organizer, a participant, or the person for whom the purchased item is intended.

If the organizer elects to proceed in making a purchase, a courtesy confirmation can be sent in operation 118 to the intended recipient along with a congratulatory message, and the actual purchase effected in operation 120.

If the organizer elects not to make a purchase, or alternatively elects to purchase an item at a price less than the aggregate amount in the money pool, a refund in the amount of the unused balance remaining in the token value as a pro rata value of the money pool is made to participants in operation 122. After a given participant is removed in operation 112, for that participant, the process stops at 124. Similarly, after a token refund is made in operation 122, or an item is purchased using the full pool value in operation 120, the process stops at 124.

FIG. 2 includes pictorial illustrations of example user interfaces (UI's) in a system of the present disclosure. The UI's may be presented to an organizer or participant in an app executing in a mobile device, for example, during one or more parts of the execution of the method 100 described above. In a first example UI 202, details of a group purchase event are displayed. This view may be presented, for example, once such an event has been established in operation 102 of FIG. 1. Event details may include aspects such as an event name or type 204 (e.g., birthday), an age 206 (e.g., 15 years), a desired aggregate pool amount 208 (e.g., $300), a gender indication 210 for the intended recipient or target person (e.g., the 15-year-old having the birthday), and one or more attributes 212 which may or may not be defined by the target person.

A notification 224 is sent to participants (for example, in operation 104 of FIG. 1) and, for each participant (for example, John, Harry, and Tom), the system causes the presentation of a second example UI 226 in the mobile device of the participant. Each UI 226 includes event details 228, an expected contribution 230 (e.g., $100 based on three participants invited to generate a $300 pool amount), and a funds transmission enabler or “Send” button 232. Clicking on the launch button 232 may open up a website or app of a third-party payment service (e.g., VENMO® or PAYPAL®) allowing the direct wiring of funds to a group purchase account.

In a third example UI 214, names 216 of the initial or current participants (e.g., John, Harry, and Sam) in the group purchase event are displayed alongside their associated initial contributions which were made, for example, during operation 106 of FIG. 1. Clicking on a “+add” button 218 allows further participants to be invited to the group purchase event, such as in operation 110 of FIG. 1. A running total (aggregate amount) 220 of the money pool (e.g., $200, as Sam's contribution is still pending) is displayed.

In a fourth example UI 222, a dynamic recommendation list is displayed, for example, in operation 112 of FIG. 1. Shown listed is an X-Box available for purchase at a price of $200, as well as a Toy available in the same amount. These items are listed because their respective purchase price of $200 is less than or equal to the running total 220 (of $200), and the items may therefore be purchased by the funds collected thus far in the pool. If, for example, Sam elects to contribute and send funds (e.g., as shown by an arrow 234), the collected pool amount will increase to $300 accordingly, and the dynamic listing in the UI 222 will change and be updated accordingly. The items in the existing listing may simply be replaced with more expensive items, or supplemented with items of a higher price, up to a limit of $300. In any event, at that point, the organizer can decide (e.g., in operation 116 of FIG. 1) what purchase should be made based on any defined attributes, and make the appropriate purchase selection (e.g., in operation 120 of FIG. 1).

Thus, in one example there is provided a system for operating a group purchase event, the system comprising: a memory comprising instructions; and one or more computer processors, wherein the instructions, when executed by the one or more computer processors, cause the one or more computer processors to perform operations comprising: initiating a digital instance of a group purchase event and defining a target balance; identifying a potential contributor list from a social or community group; transmitting an electronic communication to first and second parties on the potential contributor list via an electronic communication pathway; based on a received response to the electronic communication, authorizing the first and second parties to participate in the group purchase event; prompting the first and second parties to make a financial contribution to the group purchase event in a defined amount based on the target balance; receiving respective financial contributions from the first and second parties in the defined or another amount; based on receipt of the financial contributions, issuing respective dynamic, time-based tokens representing an amount received from each party; storing the tokens in a database; aggregating the amounts received from the first and second parties to create a money pool and storing a current balance of the money pool in a database or account; identifying and causing a presentation, in a display of an electronic device, of a list of items purchasable at prices less than or equal to the current balance; and monitoring changes in the current balance and, based on a change in the current balance, dynamically updating the displayed list of items. The operations may comprise one or more of the further method steps summarized below.

The present disclosure includes further method embodiments. One such method 300 for operating a group purchase event in a networked system is shown in FIG. 3. The method 300 may comprise: at 302, initiating a digital instance of a group purchase event and defining a target balance; at 304, identifying a potential contributor list from a social or community group; at 306, transmitting an electronic communication to first and second parties on the potential contributor list via an electronic communication pathway; at 308, based on a received response to the electronic communication, authorizing the first and second parties to participate in the group purchase event; at 310, prompting the first and second parties to make a financial contribution to the group purchase event in a defined amount based on the target balance; at 312, receiving respective financial contributions from the first and second parties in the defined or another amount; at 314, based on receipt of the financial contributions, issuing respective dynamic, time-based tokens representing an amount received from each party; at 316, storing the tokens in a database; at 318, aggregating the amounts received from the first and second parties to create a money pool and storing a current balance of the money pool in a database or account; at 320, identifying and causing a presentation, in a display of an electronic device, of a list of items purchasable at prices less than or equal to the current balance; and, at 322, monitoring changes in the current balance and, based on a change in the current balance, dynamically updating the displayed list of items.

In some examples, the dynamic, time-based tokens may include data representing an event expiry, and the method further comprises making automatic refunds to the first and second parties based on an expiry of the group purchase event or a failure to make the target balance.

In some examples, the method 300 further comprises assigning an initial value to each token; dynamically adjusting the value of each token based on one or more of a number of participants in the group purchase event, a pro rata share of the current balance of the money pool, and a level of the current balance; and automatically refunding the adjusted value, or a difference between the initial value and the adjusted value, to a participant in the group purchase event based on an expiry of the group purchase event or a failure to make the target balance.

In some examples, the dynamic, time-based tokens each include data representing a token amount, a token expiry time, and an identity of a group purchase event participant.

In some examples, identifying the list of items purchasable at prices less than or equal to the current balance includes capturing item listing results from an ecommerce platform, and filtering the item listing results based on the changes in the current balance.

In some examples, the method 300 further comprises transmitting an electronic communication to a third party on the potential contributor list via an electronic communication pathway; based on a received response to the electronic communication, authorizing the third party to participate in the group purchase event; prompting the third party to make a financial contribution to the group purchase event in a defined amount; receiving a financial contribution from the third party in the defined or another amount; based on receipt of the financial contribution, issuing a dynamic, time-based token representing the amount received from the third party; updating the current balance of the money pool accordingly; and based on the updated balance, adjusting values of all tokens currently issued.

Some embodiments include machine-readable media including instructions which, when read by a machine, cause the machine to perform the operations of any one or more of the methodologies summarized above, or described elsewhere herein.

FIG. 4 is a block diagram illustrating an example of a software architecture 402 that may be installed on a machine, according to some example embodiments. FIG. 4 is merely a non-limiting example of a software architecture, and it will be appreciated that many other architectures may be implemented to facilitate the functionality described herein. The software architecture 402 may be executing on hardware such as a machine 600 of FIG. 6 that includes, among other things, processors 610, memory 630, and I/O components 650. A representative hardware layer 404 is illustrated and can represent, for example, the machine 600 of FIG. 6. The representative hardware layer 404 comprises one or more processing units 406 having associated executable instructions 408. The executable instructions 408 represent the executable instructions of the software architecture 402, including implementation of the methods, modules, and so forth of FIGS. 1-3. The hardware layer 404 also includes memory or storage modules 410, which also have the executable instructions 408. The hardware layer 404 may also comprise other hardware 412, which represents any other hardware of the hardware layer 404, such as the other hardware illustrated as part of the machine 400.

In the example architecture of FIG. 4, the software architecture 402 may be conceptualized as a stack of layers, where each layer provides particular functionality. For example, the software architecture 402 may include layers such as an operating system 414, libraries 416, frameworks/middleware 418, applications 420, and a presentation layer 444. Operationally, the applications 420 or other components within the layers may invoke application programming interface (API) calls 424 through the software stack and receive a response, returned values, and so forth (illustrated as messages 426) in response to the API calls 424. The layers illustrated are representative in nature, and not all software architectures have all layers. For example, some mobile or special-purpose operating systems may not provide a frameworks/middleware 418 layer, while others may provide such a layer. Other software architectures may include additional or different layers.

The operating system 414 may manage hardware resources and provide common services. The operating system 414 may include, for example, a kernel 428, services 430, and drivers 432. The kernel 428 may act as an abstraction layer between the hardware and the other software layers. For example, the kernel 428 may be responsible for memory management, processor management (e.g., scheduling), component management, networking, security settings, and so on. The services 430 may provide other common services for the other software layers. The drivers 432 may be responsible for controlling or interfacing with the underlying hardware. For instance, the drivers 432 may include display drivers, camera drivers, Bluetooth® drivers, flash memory drivers, serial communication drivers (e.g., Universal Serial Bus (USB) drivers), drivers, audio drivers, power management drivers, and so forth depending on the hardware configuration.

The libraries 416 may provide a common infrastructure that may be utilized by the applications 420 and/or other components and/or layers. The libraries 416 typically provide functionality that allows other software modules to perform tasks in an easier fashion than by interfacing directly with the underlying operating system 414 functionality (e.g., kernel 428, services 430, or drivers 432). The libraries 416 may include system libraries 434 (e.g., C standard library) that may provide functions such as memory allocation functions, string manipulation functions, mathematic functions, and the like. In addition, the libraries 416 may include API libraries 436 such as media libraries (e.g., libraries to support presentation and manipulation of various media formats such as MPEG4, H.264, MP3, AAC, AMR, JPG, and PNG), graphics libraries (e.g., an OpenCit framework that may be used to render 2D and 3D graphic content on a display), database libraries (e.g., SQLite that may provide various relational database functions), web libraries (e.g., WebKit that may provide web browsing functionality), and the like. The libraries 416 may also include a wide variety of other libraries 438 to provide many other APIs to the applications 420 and other software components/modules.

The frameworks 418 (also sometimes referred to as middleware) provide a higher-level common infrastructure that may be utilized by the applications 420 or other software components/modules. For example, the frameworks 418 may provide various graphic user interface (GUI) functions, high-level resource management, high-level location services, and so forth. The frameworks 418 may provide a broad spectrum of other APIs that may be utilized by the applications 420 and/or other software components/modules, some of which may be specific to a particular operating system or platform.

The applications 420 include built-in applications 440 and/or third-party applications 442. Examples of representative built-in applications 440 may include, but are not limited to, a home application, a contacts application, a browser application, a book reader application, a location application, a media application, a messaging application, or a game application.

The third-party applications 442 may include any of the built-in applications 440, as well as a broad assortment of other applications. in a specific example, the third-party applications 442 (e.g., an application developed using the Android™ or iOS™ software development kit (SDK.) by an entity other than the vendor of the particular platform) may be mobile software running on a mobile operating system such as iOS™, Android™, Windows® Phone, or other mobile operating systems. In this example, the third-party applications 442 may invoke the API calls 424 provided by the mobile operating system such as the operating system 414 to facilitate functionality described herein.

The applications 420 may utilize built-in operating system functions (e.g., kernel 428, services 430, or drivers 432), libraries (e.g., system libraries 434, API libraries 436, and other libraries 438), or frameworks/middleware 418 to create user interfaces to interact with users of the system. Alternatively, or additionally, in some systems, interactions with a user may occur through a presentation layer, such as the presentation layer 444. In these systems, the application/module “logic” can be separated from the aspects of the application/module that interact with the user.

Some software architectures utilize virtual machines. In the example of FIG. 4, this is illustrated by a virtual machine 448. A virtual machine creates a software environment where applications/modules can execute as if they were executing on a hardware machine (e.g., the machine 600 of FIG. 6, for example). The virtual machine 448 is hosted by a host operating system (e.g., the operating system 414) and typically, although not always, has a virtual machine monitor 446, which manages the operation of the virtual machine 448 as well as the interface with the host operating system (e.g., the operating system 414). A software architecture executes within the virtual machine 448, such as an operating system 450, libraries 452, frameworks/middleware 454, applications 456, or a presentation layer 458. These layers of software architecture executing within the virtual machine 448 can be the same as corresponding layers previously described or may be different.

FIG. 5 is a block diagram 500 illustrating an architecture of software 502, which can be installed on any one or more of the devices described above. FIG. 5 is merely a non-limiting example of a software architecture, and it will be appreciated that many other architectures can be implemented to facilitate the functionality described herein. In various embodiments, the software 502 is implemented by hardware such as a machine 600 of FIG. 6 that includes processors 610, memory 630, and I/O components 650. In this example architecture, the software 502 can be conceptualized as a stack of layers where each layer may provide a particular functionality. For example, the software 502 includes layers such as an operating system 504, libraries 506, frameworks 508, and applications 510. Operationally, the applications 510 invoke application programming interface (APF) calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various graphic user interface (GUI) functions, high-level resource management, high-level location services, and so forth. The frameworks 508 can provide a broad spectrum of other APIs that can be utilized by the applications 510, some of which may be specific to a particular operating system or platform.

In an example embodiment, the applications 510 include a home application 550, a contacts application 552, a browser application 554, a book reader application 556, a location application 558, a media application 560, a messaging application 562, a game application 564, and a broad assortment of other applications such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROD™ or IOS™ software development kit (SDK) by an entity other than the vendor of the particular platform) may be mobile software running on a mobile operating system such as IOS™ ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the method 100 of FIG. 1. Additionally, or alternatively, the instructions 616 may implement FIGS. 1-3, and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. in an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an application-specific integrated circuit (ASIC), a Radio-Frequency Integrated Circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory 630 may include a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PUP), a light-emitting diode (LED) display, a liquid crystal display (LCD), a projector, or a cathode ray tube (CRT)), acoustic components (e.g., speakers), haptic components (e.g., a vibratory motor, resistance mechanisms other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, Near Field Communication (NFC) components, Bluetooth® components (e.g., Bluetooth®Low-Energy), Wi-Fi® components, and other communication components to provide communication via other modalities, The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (REID) tag reader components, NEC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF4I7, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NEC beacon signal that may indicate a particular location, and so forth.

The various memories (i.e., 630, 632, 634, and/or the memory of the processor(s) 610) and/or the storage unit 636 may store one or more sets of instructions and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1xRTT), Evolution-Data. Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 616 may be transmitted or received over the network 680 using a transmission medium via a network interface device (e.g., a network interface component included in the communication components 664) and utilizing any one of a number of well-known transfer protocols (e.g., hypertext transfer protocol (HTTP)). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for operating a group purchase event in a networked system, the method comprising:
initiating a digital instance of a group purchase event and defining a target balance;
identifying a potential contributor list from a social or community group;
transmitting an electronic communication to first and second parties on the potential contributor list via an electronic communication pathway;
based on a received response to the electronic communication, authorizing the first and second parties to participate in the group purchase event;
prompting the first and second parties to make a financial contribution to the group purchase event in a defined amount based on the target balance;
receiving respective financial contributions from the first and second parties in the defined or another amount;
based on receipt of the financial contributions, issuing respective dynamic, time-based tokens representing an amount received from each party;
storing the tokens in a database;
aggregating the amounts received from the first and second parties to create a money pool and storing a current balance of the money pool in a database or account;
identifying and causing a presentation, in a display of an electronic device, of a list of items purchasable at prices less than or equal to the current balance; and
monitoring changes in the current balance and, based on a change in the current balance, dynamically updating the displayed list of items.

2. The method of claim 1, wherein the dynamic, time-based tokens include data representing an event expiry, and the method further comprises making automatic refunds to the first and second parties based on an expiry of the group purchase event or a failure to make the target balance.

3. The method of claim 1, further comprising:
assigning an initial value to each token;
dynamically adjusting the value of each token based on one or more of a number of participants in the group purchase event, a pro rata share of the current balance of the money pool, and a level of the current balance; and
automatically refunding the adjusted value, or a difference between the initial value and the adjusted value, to a participant in the group purchase event based on an expiry of the group purchase event or a failure to make the target balance.

4. The method of claim 1, wherein the dynamic, time-based tokens each include data representing a token amount, a token expiry time, and an identity of a group purchase event participant.

5. The method of claim 1, wherein identifying the list of items purchasable at prices less than or equal to the current balance includes capturing item listing results from an ecommerce platform, and filtering the item listing results based on the changes in the current balance.

6. The method of claim 1, further comprising:
transmitting an electronic communication to a third party on the potential contributor list via an electronic communication pathway;
based on a received response to the electronic communication, authorizing the third party to participate in the group purchase event;
prompting the third party to make a financial contribution to the group purchase event in a defined amount;
receiving a financial contribution from the third party in the defined or another amount;
based on receipt of the financial contribution, issuing a dynamic, time-based token representing the amount received from the third party;
updating the current balance of the money pool accordingly; and
based on the updated balance, adjusting values of all tokens currently issued.

7. A system for operating a group purchase event, the system comprising:
a memory comprising instructions; and
one or more computer processors, wherein the instructions, when executed by the one or more computer processors, cause the one or more computer processors to perform operations comprising:
initiating a digital instance of a group purchase event and defining a target balance;
identifying a potential contributor list from a social or community group;
transmitting an electronic communication to first and second parties on the potential contributor list via an electronic communication pathway;
based on a received response to the electronic communication, authorizing the first and second parties to participate in the group purchase event;
prompting the first and second parties to make a financial contribution to the group purchase event in a defined amount based on the target balance;
receiving respective financial contributions from the first and second parties in the defined or another amount;
based on receipt of the financial contributions, issuing respective dynamic, time-based tokens representing an amount received from each party;
storing the tokens in a database;
aggregating the amounts received from the first and second parties to create a money pool and storing a current balance of the money pool in a database or account;
identifying and causing a presentation, in a display of an electronic device, of a list of items purchasable at prices less than or equal to the current balance; and
monitoring changes in the current balance and, based on a change in the current balance, dynamically updating the displayed list of items.

8. The system of claim 7, wherein the dynamic, time-based tokens include data representing an event expiry, and the method further comprises making automatic refunds to the first and second parties based on an expiry of the group purchase event or a failure to make the target balance.

9. The system of claim 7, wherein the operations further comprise:
assigning an initial value to each token;
dynamically adjusting the value of each token based on one or more of a number of participants in the group purchase event, a pro rata share of the current balance of the money pool, and a level of the current balance; and
automatically refunding the adjusted value, or a difference between the initial value and the adjusted value, to a participant in the group purchase event based on an expiry of the group purchase event or a failure to make the target balance.

10. The system of claim 7, wherein the dynamic, time-based tokens each include data representing a token amount, a token expiry time, and an identity of a group purchase event participant.

11. The system of claim 7, wherein identifying the list of items purchasable at prices less than or equal to the current balance includes capturing item listing results from an ecommerce platform, and filtering the item listing results based on the changes in the current balance.

12. The system of claim 7, wherein the operations further comprise:
transmitting an electronic communication to a third party on the potential contributor list via an electronic communication pathway;
based on a received response to the electronic communication, authorizing the third party to participate in the group purchase event;
prompting the third party to make a financial contribution to the group purchase event in a defined amount;
receiving a financial contribution from the arty in the defined or another amount;
based on receipt of the financial contribution, issuing a dynamic, time-based token representing the amount received from the third party;
updating the current balance of the money pool accordingly; and
based on the updated balance, adjusting values of all tokens currently issued.

13. A non-transitory machine-readable storage medium including instructions that, when executed by one or more processors of a machine, cause the machine to perform operations comprising:
initiating a digital instance of a group purchase event and defining a target balance;
identifying a potential contributor list from a social or community group;
transmitting an electronic communication to first and second parties on the potential contributor list via an electronic communication pathway;
based on a received response to the electronic communication, authorizing the first and second parties to participate in the group purchase event;
prompting the first and second parties to make a financial contribution to the group purchase event in a defined amount based on the target balance;
receiving respective financial contributions from the first and second parties in the defined or another amount;
based on receipt of the financial contributions, issuing respective dynamic, time-based tokens representing an amount received from each party;
storing the tokens in a database;
aggregating the amounts received from the first and second parties to create a money pool and storing a current balance of the money pool in a database or account;
identifying and causing a presentation, in a display of an electronic device, of a list of items purchasable at prices less than or equal to the current balance; and
monitoring changes in the current balance and, based on a change in the current balance, dynamically updating the displayed list of items.

14. The medium of claim 13, wherein the dynamic, time-based tokens include data representing an event expiry, and the method further comprises making automatic refunds to the first and second parties based on an expiry of the group purchase event or a failure to make the target balance.

15. The medium of claim 13, wherein the operations further comprise:
assigning an initial value to each token;
dynamically adjusting the value of each token based on one or more of a number of participants in the group purchase event, a pro rata share of the current balance of the money pool, and a level of the current balance; and
automatically refunding the adjusted value, or a difference between the initial value and the adjusted value, to a participant in the group purchase event based on an expiry of the group purchase event or a failure to make the target balance.

16. The medium of claim 13, wherein the dynamic, time-based tokens each include data representing a token amount, a token expiry time, and an identity of a group purchase event participant.

17. The medium of claim 13, wherein identifying the list of items purchasable at prices less than or equal to the current balance includes capturing item listing results from an ecommerce platform, and filtering the item listing results based on the changes in the current balance.

18. The medium of claim 13, wherein the operations further comprise:
transmitting an electronic communication to a third party on the potential contributor list via an electronic communication pathway;
based on a received response to the electronic communication, authorizing the third party to participate in the group purchase event;
prompting the third party to make a financial contribution to the group purchase event in a defined amount;
receiving a financial contribution from the third party in the defined or another amount;
based on receipt of the financial contribution, issuing a dynamic, time-based token representing the amount received from the third party;
updating the current balance of the money pool accordingly; and
based on the updated balance, adjusting values of all tokens currently issued.
